(19) United States
(12) Patent Application Publication
(10) Pub. No.: US 2023/0342186 A1
(43) Pub. Date: Oct. 26, 2023

(54) PRIORITY-BASED DIRECTED ACYCLIC GRAPH SCHEDULING

(71) Applicant: HEWLETT PACKARD ENTERPRISE DEVELOPMENT LP, Houston, TX (US)

(72) Inventor: Somasundaram Arunachalam, Bangalore (IN)

(21) Appl. No.: 17/660,694

(22) Filed: Apr. 26, 2022

(51) Int. Cl. G06F 9/48

(52) U.S. Cl. CPC G06F 9/4818; G06F 9/4881

(57) ABSTRACT

A process includes providing a directed acyclic graph (DAG) that represents an execution order for a plurality of tasks. The DAG includes a plurality of nodes, and each node corresponds to a corresponding task subset of at least one task of the set of tasks. The process includes associating a first priority with a given successor node for the given successor node to execute after a first predecessor node. The given successor node is connected to the first predecessor node by a first edge of the DAG. The process includes associating a second priority with the given successor node for the given successor node to execute after a second predecessor node. The given successor node is connected to the second predecessor node by a second edge of the DAG. The process includes scheduling tasks for execution based on the DAG. The scheduling includes, based on the first and second priority, scheduling the task subset corresponding to the given successor node to execute after the task subset corresponding to the first predecessor node executes; or scheduling the task subset corresponding to the given successor node to execute after the task subset corresponding to the second predecessor node executes.

### BACKGROUND

A cluster is a group of interconnected computers, or nodes, which combine their individual processing powers to function as a single, high performance machine. A cluster may be used for a number of different purposes, such as load balancing, high availability (HA) server applications and parallel processing.

### BRIEF DESCRIPTION OF THE DRAWINGS

FIG. 1 is a schematic diagram of a computer system according to an example implementation.

FIGS. 2 and 4 are illustrations of priority directed acyclic graphs (DAGs) having respective associated priorities according to an example implementation.

FIG. 3 is an illustration of a linked list structure that may be used to represent a priority DAG and associate successor nodes of the priority DAG with relative multipath (RMP) node priorities according to an example implementation.

FIG. 5 is an illustration of the association of priority DAGs with corresponding priorities and the mapping of priority DAGs to RMP node priority queues according to an example implementation.

FIG. 6 is an illustration of a priority DAG for controlling a motion of an autonomous vehicle according to an example implementation.

FIG. 7 is an illustration of a software defined network (SDN) data plane depicting a relationship among data path elements of the SDN data plane and the dynamic adjustment of RMP node priorities according to an example implementation.

FIG. 8 is a flow diagram depicting a process to schedule tasks for execution based on a DAG that has priorities associated with nodes of the DAG according to an example implementation.

FIG. 9 is a block diagram of an apparatus that includes a hardware processor to schedule tasks for execution based on a DAG that has priorities associated with nodes of the DAG according to an example implementation.

FIG. 10 is an illustration of instructions stored on a non-transitory machine-readable storage medium, that, when executed by a machine, cause the machine to schedule tasksets corresponding to nodes of a DAG, which are associated with priorities according to an example implementation.

### DETAILED DESCRIPTION

A high performance computing (HPC) system may include a large number (e.g., hundreds, if not thousands or tens of thousands) of compute nodes (e.g., servers) that are networked together in a cluster for purposes of combining their individual processing powers to solve computationally-intensive problems. As examples, the computationally-intensive problems may be related to modeling, genome study, DNA study, computational biology, computational chemistry, earth science-related studies, space study, and so forth.

In general, machine-readable instructions (e.g., program code) may set forth a logical workflow of transformations on data to solve a computationally-intensive problem. In this context, a “transformation” refers to a function that operates on input data to produce an output data. The data may be partitioned into logical partitions, or datasets (e.g., resilient distributed datasets (RDDs)), which allows compute nodes to perform different parts of some transformations (e.g., map, transformations, filter transformations, reduce transformations, and so forth) individually and in parallel. Some transformations (e.g., a shuffle operation in which data is shuffled among a set of compute nodes) may be performed by a group of compute nodes in a nonparallel fashion.

A logical workflow of transformations does not inform a cluster how to specifically perform the workflow. For this purpose, a logical workflow of transformations may be converted into a physical execution plan, which sets forth specific tasks for compute nodes of the cluster. A physical execution plan may include a sequence of stages. Each stage may be associated with a set of tasks (called a “taskset” herein) that are to be performed by a set of compute nodes of a cluster computing system. The stage boundaries may be determined in a manner that assigns similar transformation types to the same stage. For example, if a logical workflow has first transformations in which parallel processing may be used followed by a shuffling transformation, then the corresponding part of the physical execution plan may a first stage that includes a taskset for performing the parallel processing transformations and a second, subsequent stage that includes a taskset for performing the shuffling transformation.

A cluster may include a scheduler that processes a physical execution plan for purposes of scheduling the tasks of the physical execution plan for execution by compute nodes of the cluster. The physical execution plan may be in the form a graph, such as a directed acyclic graph (DAG). In general, a “graph” refers to a collection of vertices, or nodes, which are connected by edges. Each node may represent a particular stage of the physical execution plan, and correspondingly, each node may correspond to a taskset related to one or multiple transformations that operate on and produce datasets. A “DAG” is a specific type of graph. A DAG is “directed” in that each edge of the graph is directed, or represents a one-way direction between a pair of nodes (i.e., a predecessor node and an immediate successor node) of the graph. The DAG is “acyclic” in that the graph has no directed cycles, i.e., no portion of the graph cycles, or forms a closed loop.

A “taskset,” as used herein, generally refers to a set of one or multiple tasks that are associated with a particular stage of a physical execution plan and are associated with a node of the DAG. A “task” refers to a unit of execution for a particular compute node of the cluster. As used herein, “predecessor” and “successor” are used to refer to an order in which the DAG is traversed via a directed edge. “Immediate” is used when discussing a pair of nodes to mean that the nodes are adjacent to each other, i.e., the nodes are directly connected to each other by an edge. Therefore, a directed edge may extend from a predecessor node to an immediate successor node, or stated differently, the directed edge may extend to the successor node from an immediate predecessor node.

A DAG scheduler may process a DAG for purposes of scheduling tasks among nodes of a cluster. The DAG scheduler may traverse a DAG such that for each node of the DAG, the DAG scheduler schedules the tasks of the taskset corresponding to the node, before the DAG scheduler proceeds with scheduling the tasks of the taskset corresponding to the immediate successor node.

Using a DAG to represent a physical execution plan may be rather inflexible for purposes of responding to a dynamic environment. An example of a dynamic environment is a self-driving, or autonomous, vehicle, which may operate without human involvement in response to the vehicle sensing its environment. The environment may unpredictively change, such as, for example, when the vehicle senses an unexpected object in the vehicle’s current path. When a DAG represents a physical execution plan for an autonomous vehicle, there may be multiple tasksets (corresponding to nodes of the DAG) that are directed to handling the path planning, monitoring and control of the vehicle.

For example, a particular car motion control taskset may be related to tasks directed to controlling the motion of the autonomous vehicle along a particular course. There may be more than one possible scenario that might preempt the car motion control taskset and should be handled by another taskset. For example, the car motion control taskset may be preempted by actions taken by a human operator setting a cruise control speed, and this preemption may involve transitioning to a cruise control taskset. As another example, the car motion control taskset may be preempted by a progressive brake control taskset for purposes of reducing the speed of the vehicle. As another example, the car motion control taskset may be preempted due to an object being detected, and which may involve transitioning to executing an object detection handling taskset.

A DAG that has only single directed edges from its node does not accommodate the situation in which conditions for more than one scenario are simultaneously satisfied. For example, for the above-described autonomous vehicle motion control, a user may be operating cruise control buttons or levers on the vehicle simultaneously with an unexpected object being detected in the vehicle’s path. Stated differently, there may be more than one scenario that warrants transitioning from a node of the DAG associated with the motion control taskset.

In accordance with example implementations that are described herein, a DAG may have multiple candidate paths (or “execution paths”) that originate from a given node. In this manner, in accordance with example implementations, a DAG may have multiple candidate paths from a given predecessor node, where each candidate path extends from the given predecessor node along through an associated directed edge and to a different immediate successor node. For example, a DAG for an autonomous vehicle may have multiple candidate paths (corresponding to multiple directed edges and multiple immediate successor nodes) that originate from a node corresponding to the motion control taskset. A first candidate path may include a first immediate successor node corresponding to a cruise control taskset. A second candidate path may include a second immediate successor node corresponding to a progressive brake control taskset. A third candidate path may include a third immediate successor node corresponding to the object detection handling taskset.

A potential challenge with multiple candidate paths in DAG scheduling is that the condition(s) for transitioning to more than one candidate path may be simultaneously satisfied. For the example, the condition(s) for executing a progressive brake control taskset may be simultaneously satisfied with the condition(s) for executing an object detection handling taskset.

A “priority DAG” is described herein in accordance with example implementations. In this context, a “priority DAG” generally refers to DAG that has alternate candidate paths (or “candidate execution paths”), and the candidate paths are associated with relatively priorities (which may also be called “multipath priorities, “relatively multipath node priorities,” or “RMP node priorities” herein). Sated differently, in accordance with example implementations, for multiple candidate paths, or choices, from a given predecessor node, each candidate path may be assigned a different relative priority than the other path(s), such that if conditions are concurrently satisfied for more than two candidate paths, the DAG scheduler selects the candidate path that has the relatively highest priority. For the autonomous vehicle example discussed above, the object detection handling taskset may have a higher relative priority than the cruise control taskset and the progressive brake control taskset, so that the DAG scheduler always schedules the object handling taskset in the event that an unexpected object is detected. Continuing the example, the progressive brake control taskset may be associated with a higher priority than the cruise control taskset, so that if the condition for transitioning to both tasksets are simultaneously satisfied, the DAG scheduler will schedule the progressive brake control taskset for execution.

The priorities may be associated with nodes of the priority DAG. For the examples above, the multiple candidate paths originate with a predecessor node of the priority DAG, and there is a choice, from the predecessor node, among multiple immediate successor nodes that correspond to the multiple execution paths. The choice of node may occur in the reversed order as well. In this manner, in accordance with example implementations, a priority DAG may have multiple candidate paths that terminate at a particular successor node. Stated differently, there may be multiple choices of immediate predecessor nodes for a given successor node. In this manner, a first candidate path may traverse a first predecessor node and terminate at an immediate successor node, and a second candidate path may traverse a second predecessor node and terminate at the same immediate successor node. For this example, both candidate paths may have associated relative priorities (i.e., the predecessor nodes may have associated RMP node priorities), which control which candidate path the DAG scheduler selects if conditions for both paths are satisfied.

In accordance with example implementations, one or multiple priorities of a priority DAG may be dynamically assigned. For example, in accordance with some implementations, an executing taskset of the DAG may evaluate and possibly adjust an RMP node priority of the same DAG. As a more specific example, a priority DAG may relate to networking route optimization, i.e., selecting an optimum route for packets through data path elements of software defined network (SDN). In this manner, the priority DAG may contain nodes (and corresponding tasksets) that correspond to data path devices of the SDN. One or multiple of these nodes may have a choice of candidate immediate successor nodes, which corresponding to multiple candidate execution paths and multiple data plane routing paths. The RMP node priorities of the candidate immediate successor nodes may be dynamically adjusted based on current network performance metrics (e.g., metrics representing bandwidth, latency, numbers of dropped packets, and so forth). In accordance with some implementations, executing tasks of the DAG’s tasksets may dynamically adjust the RMP node priorities based on the current network performance metrics so that over time, preference is given to the currently better performing segments of the data plane.

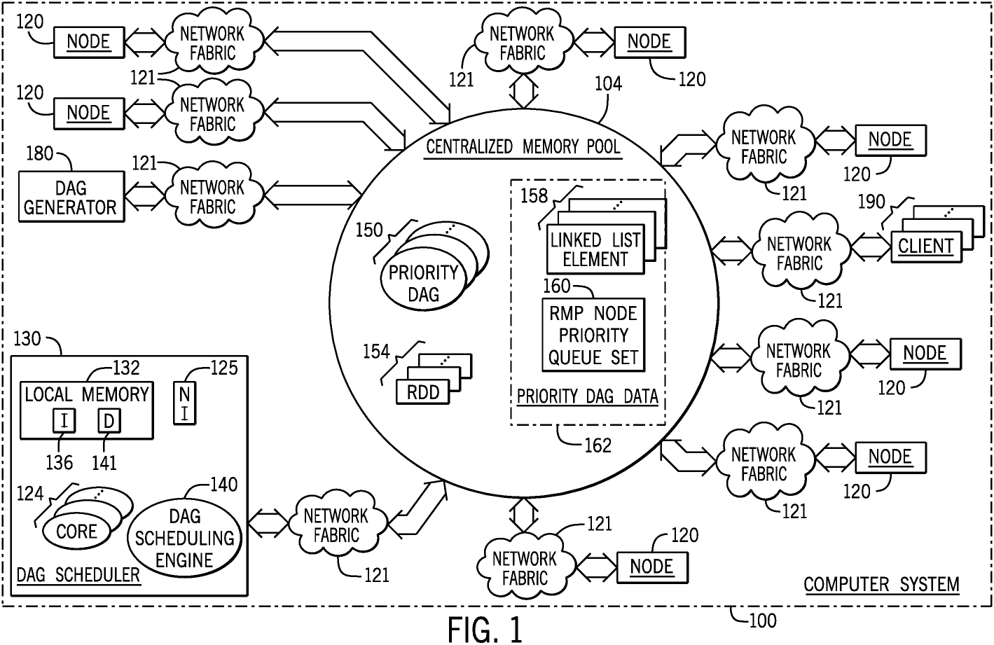

Referring to FIG. 1, in accordance with example implementations, a computer system 100 includes nodes 120 that may be organized as a cluster. The nodes 120 include compute nodes (which are referred to as “compute nodes 120” herein), and one or multiple nodes 120 may be administrative nodes of the cluster, in accordance with example implementations. The computer system 100 includes a DAG scheduler 130 that schedules tasks for execution by the compute nodes 120.

For the example implementation that is depicted in FIG. 1, the computer system 100 has a memory-oriented distributed computing (MODC) architecture in which a centralized memory pool 104 of the computer system 100 is shared by the nodes 120. In accordance with example implementations, the nodes 120 may access the memory pool 104 via relatively high bandwidth network fabric 121, such as Gen-Z fabric or other network fabric. The memory pool 104 may include physical storage devices that corresponds to a heterogeneous collection or a homogeneous collection of physical, non-transitory storage media devices.

As examples, in accordance with some implementations, the physical, non-transitory storage media devices may include one or more of the following: semiconductor storage devices, memristor-based devices, magnetic storage devices, phase change memory devices, a combination of devices of one or more of these storage technologies, storage devices for other storage technologies, and so forth. Moreover, in accordance with some implementations, the physical, non-transitory storage media devices may be volatile memory devices, non-volatile memory devices, or a combination of volatile and non-volatile memory devices. In accordance with some implementations, the non-transitory storage media devices may be part of storage arrays, as well as other types of storage subsystems.

The node 120, in accordance with example implementations, may be a computer platform (e.g., a blade server, a laptop, a router, a rack-based server, a gateway, a supercomputer and so forth), a subpart of a computer platform (e.g., a compute node corresponding to one or multiple processing cores of a blade server), or multiple computer platforms (e.g., a compute node corresponding to a cluster). The nodes 120 may all have the same architecture or may have different architectures, depending on the particular implementation.

Although FIG. 1 depicts a MODC architecture for the computer system 100, the computer system 100 may have a non-MODC architecture, in accordance with further implementations. For example, in accordance with a further example implementation, the computer system 100 may alternatively have a processor-centric architecture in which compute nodes 120 are the center of the architecture. In a processor-centric architecture, local memories of the compute nodes 120 may be shared by the compute nodes 120. In this context, the “local memory” of the compute node 120 refers to a memory that is dedicated to the compute node 120, such that the compute node 120 controls access to the memory. As an example, the local memory may be a memory dedicated to one or multiple central processing unit (CPU) cores of the compute node. In the following discussion, it is assumed that the computer system 100 has an MODC architecture.

In accordance with example implementations, a client 190 (e.g., a computer platform that receives input from a user) may provide data representing a logical execution workflow to a DAG generator 180 of the computer system 100. The data may be, for example, machine-readable instructions (e.g., program code) that represents a logical execution flow of transformations to be performed on partitioned datasets (e.g., RDDs 154), beginning with one or multiple input datasets and ending with one or multiple datasets that represent the end result of the logical execution flow. As an example, the data representing the logical execution workflow may be in the form of a file that is uploaded and is accessible by the DAG generator 180. As another example, the data representing the logical execution workflow may be provided through a command line interface of the DAG generator 180. As another example, the data representing the logical execution flow may be provided to the DAG generator 180 through a graphical user interface (GUI) of the DAG generator 180. Regardless of how the logical execution workflow is provided to the DAG generator 180, in accordance with example implementations, the DAG generator 180 converts the logical execution workflow into one or multiple priority DAGs 150. These priority DAG(s) 150 represent a physical execution plan that corresponds to the logical execution workflow, and the priority execution plan contains tasks to be executed by compute nodes 120 of the computer system 100.

In general, the vertices, or nodes, of a priority DAG 150 represent respective stages of a physical execution plan. Each node of the priority DAG 150, in accordance with example implementations, corresponds to a stage that is associated with a taskset. A “taskset” includes one or multiple tasks to be executed either by a single compute node 120 or by multiple compute nodes 120 working in concert. Here “in concert” refers to the compute nodes 120 working in either a parallel fashion or in a nonparallel fashion. As an example, multiple compute nodes 120 may execute tasks of a taskset to perform respective transformations on partitioned datasets (e.g., RDDs 154) in parallel. As another example, multiple compute nodes 120 may execute tasks of a taskset to transform data in a nonparallel fashion, such as a transformation that involves shuffling data among the compute nodes 120.

Due to the edges of the priority DAG 150 being directed (i.e., representing a one-way direction from one node to another node), the priority DAG 150 defines an execution sequence, or order, for executing the tasksets that correspond to the nodes of the DAG 150. In the context used herein, a “priority DAG” refers to a DAG that includes one or multiple nodes that have RMP node priorities assigned to them. For a given predecessor node of the priority DAG, which is connected, via multiple edges, to multiple immediate successor nodes, RMP node priorities may be assigned to the immediate successor nodes (i.e., each immediate successor node has a different RMP node priority). For a given successor node of the priority DAG, which is connected, via multiple edges, to multiple immediate predecessor nodes, RMP node priorities may be assigned to the immediate predecessor nodes. Regardless of whether a given node is connected to multiple immediate successor nodes or is connected to multiple immediate predecessor nodes, the node is part of respective multiple candidate execution paths. Due to the existence of multiple candidate execution paths, the priority DAG 150 may alternatively be referred to as a “multipath” DAG, or “multipath priority DAG 150.”

In accordance with example implementations, the computer system 100 includes a DAG scheduler 130 that processes the priority DAGs 150 for purposes of scheduling tasks that are to be executed by compute nodes 120 of the computer system 100. The DAG scheduler 130 may be a particular node 120 or group of nodes 120 of the computer system 100, in accordance with example implementations. In general, the DAG scheduler 130 includes a DAG scheduling engine 140 to process the priority DAGs 150 and schedule the tasks for execution by compute nodes 120.

The DAG scheduling engine 140, in the processing of a given priority DAG 150, traverses the nodes of the priority DAG 150 according to the execution order, or sequence, that is set forth by the directed edges of the priority DAG 150. Each node of the priority DAG 150 may be associated with one or multiple tasksets, and the taskset(s) include tasks to be executed by the compute nodes 120 as part of a stage of a physical execution plan. For a given node of the priority DAG 150, the DAG scheduling engine 140 identifies one or multiple compute nodes 120 to execute the tasks associated with the given node. A given node of the priority DAG 150 may itself be another priority DAG 150.

The DAG scheduling engine 140 may base the identification of the compute node(s) 120 for executing a given taskset based on any of a number of different criteria, such as availability of the compute nodes 120, performance metrics (e.g., bandwidth, latency, processor utilization, and so forth) associated with the compute nodes 120, the number of tasks in the taskset, the nature of the transformation(s) associated with the taskset, the availability of cached data from previous compute node 120 processing results, and so forth. In accordance with some implementations, the DAG scheduling engine 140 directly communicates the tasks with task schedulers of the identified compute nodes 120 for purposes of scheduling the tasks for execution by these compute nodes 120. In accordance with further implementations, the DAG scheduling engine 140 communicates the compute node identifications to a DAG task scheduler (not shown) that handles communicating tasks with the task schedulers for individual compute nodes 120.

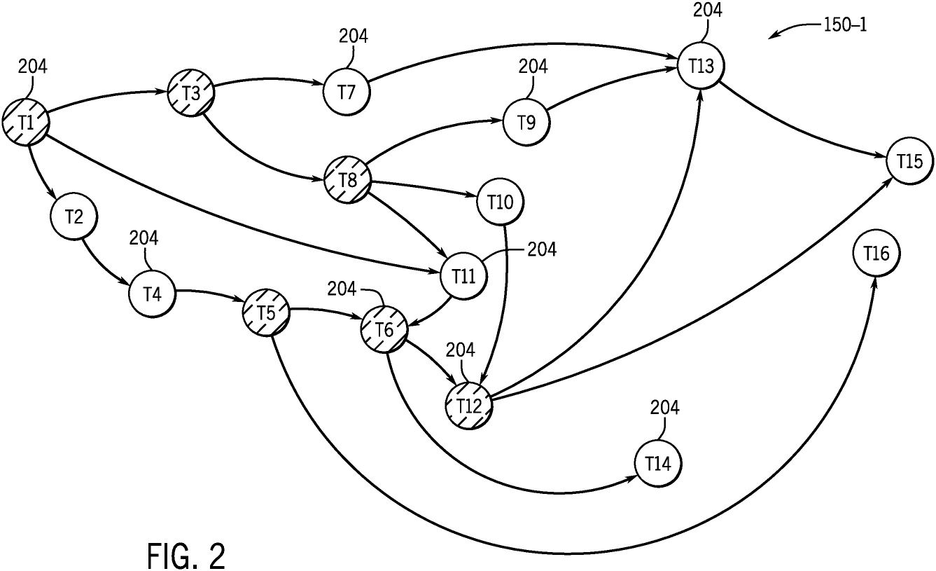

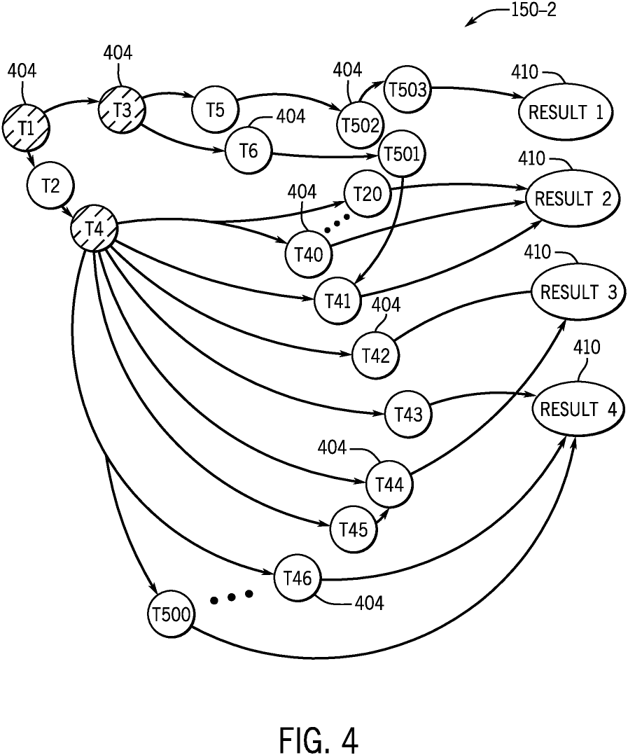

In accordance with example implementations, the DAG scheduling engine 140 processes a priority DAG 150, one node at a time, for purposes of scheduling the tasks for compute nodes 120 to execute. After scheduling the tasks for a given node, the DAG scheduling engine 140 selects the next node to process. In some cases, the “next node” may be only choice. However, in other cases, selecting the “next node” may involve the DAG scheduling engine 140 evaluating multiple choices (i.e., evaluating candidate next nodes) based on respective RMP node priorities associated with these choices. To be a valid candidate node for consideration, one or multiple conditions for selecting the candidate node are satisfied, with the remaining criterion for selecting the candidate node being the RMP node priority associated with the candidate node. In accordance with example implementations, either 1. the candidate node is one of multiple candidate immediate successor nodes, or 2. the candidate node is one of multiple candidate immediate predecessor nodes, as further described herein in connection with example priority DAGs 150-1 and 150-2 of FIGS. 2 and 4, respectively.

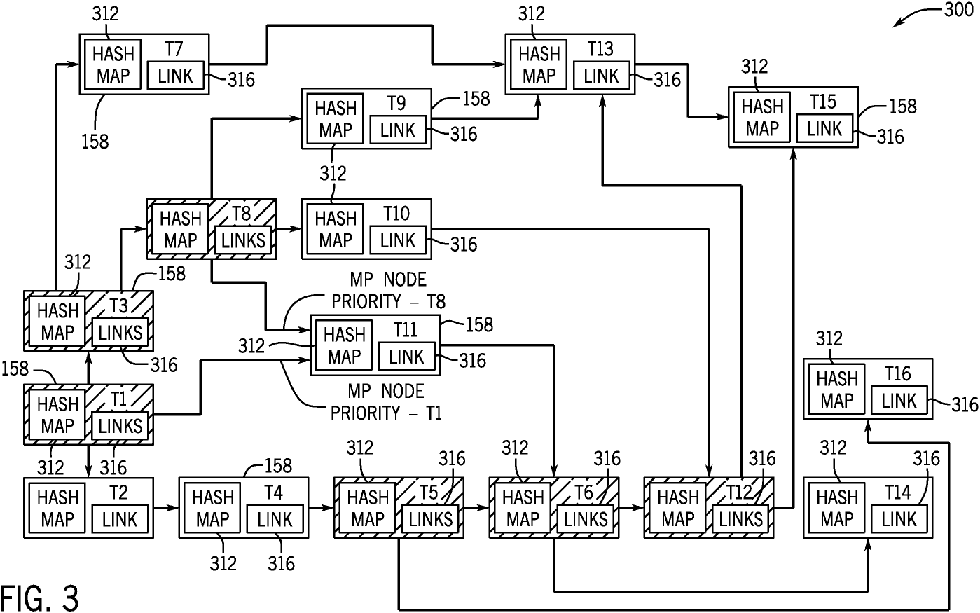

Still referring to FIG. 1, in accordance with example implementations, the priority DAG 150 may be represented by a corresponding set of priority DAG data 162, and the DAG scheduling engine 140 accesses the priority DAG data 162 for purposes of acquiring information about the structure of the priority DAG 150 and the RMP node priorities that are associated with the priority DAG 150. The priority DAG data 162, in accordance with example implementations, includes data that represents a linked list structure of elements 158. In accordance with example implementations, the elements 158 correspond to respective nodes of the priority DAG 150 (i.e., each node of the priority DAG 150 corresponds to one of the elements 158), and each element 158 contains one or multiple links that correspond to the edges of the DAG 150 that extend from the corresponding node. Moreover, in accordance with example implementations, the elements 158 contain respective hash maps that indicate, or represent, the RMP node priorities (if any) that are relevant for the corresponding node. In this manner the RMP node priorities (if any) for a given element are the RMP node priorities for the candidate node choices relative to the node that corresponds to the element 158. An example linked list structure for the example priority DAG 150-1 of FIG. 2 is illustrated in FIG. 3 and is further described herein.

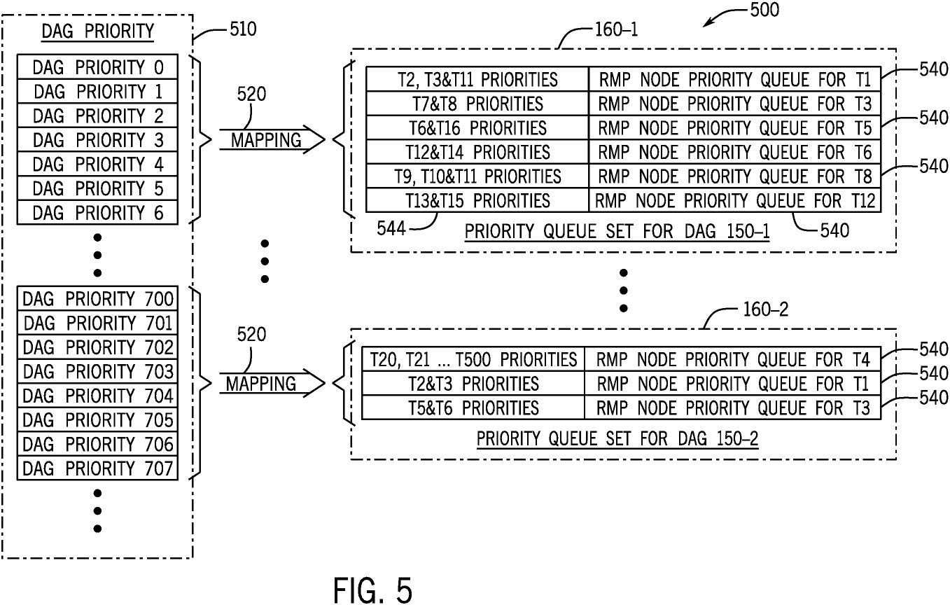

In accordance with example implementations, the priority DAG data 162 further includes data that represents one or multiple RMP node priority queue sets 160. Each RMP node priority queue set 160 corresponds to a particular priority DAG 150 and contains a group, or set, of queues that contain data that represent the RMP node priorities for the priority DAG 150. For example, in accordance with some implementations, each queue of the RMP node priority queue set 160 may be associated with a particular node of the DAG 150 that is associated with a set of candidate nodes; and the queue contains the RMP priorities of the candidate nodes. In accordance with some implementations, queues of an RMP node priority queue set 160, such as the RMP node priority queue sets that are depicted in Table 1 below and depicted in FIG. 5, may be individually associated with predecessor nodes that have candidate immediate successor nodes; and each of these queues may contain data representing the RMP priorities of these candidate immediate successor nodes. Moreover, in accordance with some implementations, queues of an RMP node priority queue set 160 may be individually associated with successor nodes that have candidate immediate predecessor nodes; and each of these queues may contain data representing the RMP priorities of these candidate immediate predecessor nodes.

The DAG scheduling engine 140 may, in accordance with example implementations, be implemented via machine-readable instructions (i.e., “software”) that are executed by a hardware processor. In accordance with further implementations, the DAG scheduling engine 140 may be implemented by dedicated hardware (e.g., logic, a field programmable gate array (FPGA), an application specific integrated circuit (ASIC), a complex logic device (CPLD), and so forth) that does not execute machine-readable instructions, or by a combination of dedicated hardware and a hardware processor that executed machine-readable instructions. For the implementation that is depicted in FIG. 1, the DAG scheduler 130 may be a node 120 and may contain a network interface 125 and a hardware processor that includes one or multiple processing cores 124 (e.g., one or multiple central processing unit (CPU) semiconductor packages, one or multiple CPU cores, and so forth). In this manner the processing core(s) 124 may execute machine-executable instructions 136 (or “software”) for purposes of forming the DAG scheduling engine 140. In accordance with some implementations, the DAG scheduler 130 may have a local memory 132 that stores the instructions 136 and data 141 representing initial, intermediate and/or final data related to the scheduling by the DAG scheduling engine 140. In accordance with further implementations, all or part of the instructions and/or data 141 may be stored in the centralized memory pool 104. In accordance with some implementations, the DAG scheduler 130 (and accordingly, the DAG scheduling engine 140) may be a distributed entity that is located on multiple nodes 120 of the computer system 100.

In the following discussion, it is assumed that the DAG scheduler 130 performs its scheduling-related actions using the DAG scheduling engine 140.

FIG. 2 depicts a specific priority DAG 150-1 in accordance with an example implementation. Referring to FIG. 2 in conjunction with FIG. 1, in general, the priority DAG 150-1 includes nodes 204, which are ordered such that the tasks of the tasksets of respective nodes 204 are scheduled and executed in a particular order. The tasksets of the corresponding nodes 204 are represented by “T” and a corresponding numerical suffix. In this manner, the nodes 204 of the priority DAG 150 correspond to respective tasksets called “T1,” “T2,” T3,” and so forth, with the first node 204 of the priority DAG 150-1 corresponding to taskset T1. Each cross-hatched node 204 (i.e., the T1, T3, T4, T6, T8 or T12 node 204) is a predecessor node 204 for which there is a choice of multiple immediate successor nodes 204 for the predecessor node 204, i.e., nodes for which multiple edges directed away from each of these nodes 204. For each of these predecessor nodes 204, RMP node priorities are associated with the corresponding set of candidate immediate successor nodes 204. For example, the T1 node 204 is connected by a directed edge to the T2 node 204, is connected to the T3 node 204 by a second directed edge and is connected to the T11 node 204 by a third directed edge. The priority DAG 150-1 associates RMP priorities with the T2, T3 and T11 nodes 204. As another example, the T6 node 204 is connected by a directed edge to the T12 node 204 and is connected by another directed edge to the T14 node. The priority DAG 150-1 associates RMP priorities with the T12 and T14 nodes 204.

The cross-hatched nodes 204 of FIG. 2 are predecessor nodes 204 that from which multiple candidate edges are directed to respective immediate successor nodes 204. The priority DAG 150-1 also has examples of a successor node 204 which is connected by directed edge to multiple candidate immediate predecessor nodes 204. The T11 node 204 is one example of such a successor node 204. The T1 and T8 nodes 204 are candidate predecessor nodes for the T11 node 204. The priority DAG 150-1 associates respective RMP priorities to the T1 and T8 nodes 204. The T6, T12, T13 and T15 nodes 204 are other examples of a successor node 204 that has multiple candidate immediate predecessor nodes 204.

The following table depicts an example content of queues of an RMP priority queue set 160 (FIG. 1) for certain predecessor nodes 204 of the priority DAG 150-1:

TABLE 1

| | | |
|---|---|---|
| Predecessor Node 204 | Immediate Successor Nodes 204 | RMP Priority Queue of Queue Set 160 |
| T1 | T2, T3, T11 | RMP Priority Queue for {T2, T3, T11} |
| T3 | T7, T8 | RMP Priority Queue for {T7,T8} |
| T5 | T6, T16 | RMP Priority Queue for {T6, T16} |
| T6 | T12, T14 | RMP Priority Queue for {T12, T14} |
| T8 | T9, T10, T11 | RMP Priority Queue for {T9, T10, T11} |
| T12 | T13, T15 | RMP Priority Queue for {T13, T15} |

For this example, each queue corresponds to a respective predecessor node 204 of the DAG priority queue 150-1, which have multiple candidate immediate successor node s 204. For example, as depicted in row four of Table 1, the T6 node 204 has the T12 and T14 immediate successor nodes 204 and corresponds to an RMP node priority queue set 160 that contains the RMP node priorities for the T12 and T14 nodes 204.

In accordance with further example implementations, the given RMP priority queue set 160 may include one or multiple RMP priority queues that correspond to respective successor nodes 204, where each of these successor nodes 204 has multiple candidate immediate predecessor nodes. For this example, the RMP priority queue for a given successor node has data representing the RMP node priorities for the candidate immediate predecessor nodes.

FIG. 3 depicts a linked list architecture 300 for the priority DAG 150-1 of FIG. 2 according to an example implementation. Referring to FIG. 3 in conjunction with FIGS. 1 and 2, the linked list architecture 300 includes a hierarchical arrangement of linked list elements 158, corresponding to the order established by the directed edges of the DAG 150-1. Each element 158 is associated with a particular node 204 of the priority DAG 150-1 and contains information that allows the DAG scheduler 130 to determine relevant RMP node priorities (if any) for the associated node 204. For this example, the cross-hatching in FIG. 3 highlights the elements 158 whose corresponding nodes 204 each have multiple candidate successor nodes 204. Moreover, the taskset notation (e.g., T1, T2, T3 and so forth) for each linked list element 158 of FIG. 3 represents the associated node 204 of the priority DAG 150-1 of FIG. 2.

In accordance with some implementations, each element 158 contains data representing one or multiple links 316 to the element(s) 158 corresponding to the immediate successor node(s) 204. For example, for the T1 element 158, the element 158 stores data representing links 316 to the T2 element 158, the T3 element 158 and the T11 element 158. Moreover, in accordance with example implementations, each element 158 stores data representing a hash map 312. In accordance with example implementations, the hash map 312 allows the DAG scheduler 130 to determine the relevant RMP node priorities (if any). In accordance with some implementations, the hash map 312 is a probabilistic filter (e.g., a Bloom filters). For example, in accordance with some implementations, the DAG scheduler 130 may apply multiple hash functions to an identifier for the node 204 to produce multiple corresponding hash values. The DAG scheduler 130 may then apply the hash values to the hash map 312 for purposes of identifying the RMP node priorities that are relevant to the associated node 204, including ruling out irrelevant RMP node priorities.

In the context used herein, a “hash” (also called a “hash value”) is produced by the application of a cryptographic hash function to a value (e.g., an input, such as an image). A “cryptographic hash function” may be a function that is provided through the execution of machine-readable instructions by a processor (e.g., one or multiple central processing units (CPUs), one or multiple CPU processing cores, and so forth). The cryptographic hash function may receive an input, and the cryptographic hash function may then generate a hexadecimal string to match the input. For example, the input may include a string of data (for example, the data structure in memory denoted by a starting memory address and an ending memory address). In such an example, based on the string of data the cryptographic hash function outputs a hexadecimal string. Further, any minute change to the input may alter the output hexadecimal string. In another example, the cryptographic hash function may be a secure hash function (SHA), any federal information processing standards (FIPS) approved hash function, any national institute of standards and technology (NIST) approved hash function, or any other cryptographic hash function. In some examples, instead of a hexadecimal format, another format may be used for the string.

It is noted that the example priority DAG 150-1 of FIG. 2 is a simplified example, as a priority DAG 150 may a relatively large number (e.g., hundreds, if not thousands or more) of nodes; a given predecessor node of a priority DAG 150 may have a relatively large number (e.g., hundreds, if not thousands or more) of immediate successor nodes; and a given successor node of a priority DAG 150 may have a relatively large number of immediate predecessor nodes. Moreover, in accordance with example implementations, a given node of a priority DAG 150 may itself be a DAG.

FIG. 4 depicts another example priority DAG 150-2 in accordance with some implementations. Referring to FIG. 4 in conjunction with FIG. 1, the DAG 150-2 has corresponding nodes 404. Similar to the notation used in the representation of the priority DAG 150-1 of FIG. 2, the tasksets of the corresponding nodes 404 are represented by “T” and a corresponding numerical suffix; and the cross-hatched nodes 404 (i.e., the T1, T3 and T4 nodes 404) are predecessor nodes 404 for which there are a choice of multiple immediate successor nodes 404 for each predecessor node 404. For this example, the T4 node 404 is a predecessor node that has a choice of 481 immediate successor nodes 404, i.e., the T20 to T500 nodes 404. Based on the priorities that are associated with the successor nodes 404, the DAG scheduler 130 may, after processing the T4 taskset, invoked one of tasksets corresponding to one of the T20 to T500 nodes 404. The T4 node 404, for example, may be associated with an RMP node priority queue that stores data representing priorities (e.g., values of 1 to 481) for the T20 to T500 nodes 404.

As depicted in FIG. 4, different results 410 (e.g., Result 1, Result 2, Result 3 or Result 4) may be produced due to the execution of the priority DAG 150-2, depending on the RMP node priority-based selection of nodes 404. In this manner, depending on the priorities, the DAG scheduler 130 may effectively select one of multiple candidate execution paths (associated with different sets of nodes 404), resulting in the execution of specific tasks corresponding to the nodes 404 of the selected candidate execution path.

In accordance with example implementations, the priority DAGs 150 may be independent and prioritized, and the DAG scheduler 130 may select a particular DAG 150 for processing based on its associated priority value. FIG. 5 depicts DAG priorities 510 associated with corresponding independent priority DAGs. Referring to FIG. 5 in conjunction with FIGS. 1, 2 and 4, multiple priority DAGs may, at a given time, satisfy conditions for being selected by the DAG scheduler 130, and from these priority DAGs, the DAG scheduler 130 may select the priority DAG having the highest priority. After selecting the priority DAG, the scheduler 130 may then map (as depicted at reference numeral 520) the selected priority DAG to the corresponding RMP priority queue set 160 and then use the corresponding linked list structure that corresponds to the selected priority DAG.

FIG. 5 depicts example priority queue sets 160-1 and 160-2 for the priority DAGs 150-1 and 150-2, respectively. Each priority queue set 160-1, 160-2 contains RMP priority node queues 540 corresponding to the predecessor nodes of the priority DAG which have the choice of multiple candidate immediate successor nodes. A given queue 540, as indicated at reference numeral 544, contains data representing the priorities for the immediate candidate successor nodes for the corresponding predecessor node. For example, the priority queue set 160-1 for the priority DAG 150-1 has an RMP priority queue 540 corresponding to the T12 node of the priority DAG 150-1 and containing data representing respective relative priorities for the T13 and T15 nodes of the priority DAG 150-1.

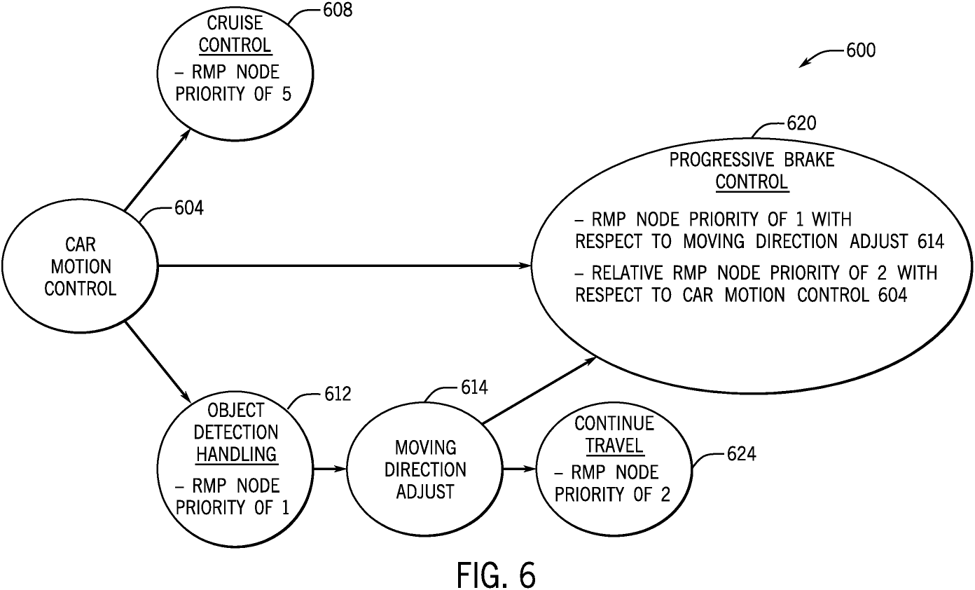

FIG. 6 depicts an example priority DAG 600 associated with motion control aspects of a self-driving, or autonomous vehicle, in accordance with an example implementation. In particular, the priority DAG 600 includes a node 604 that has an associated taskset corresponding to car motion control and nodes 608 and 612 that have respective tasksets corresponding to cruise control and object detection handling, respectively. The nodes 608, 612 and 620 present potential multiple candidate choices for immediate successor nodes from the predecessor node 604. For this example, the higher RMP node priority corresponds to a lower priority value, and vice versa. The node 612 (object detection handling) has a higher RMP node priority than either node 608 (cruise control) or node 620 (progressive brake control) to accommodate the detection of an unexpected object in the path of the vehicle.

In accordance with example implementations, one or multiple priorities of a given DAG may be dynamically assigned. For example, in accordance with some implementations, an executing taskset of the DAG may evaluate and possibly adjust a priority of the DAG. As a more specific example, a priority DAG may relate to networking route optimization, i.e., selecting an optimum route for packets through the data plane of a software defined network (SDN). In this manner, the DAG may contain tasksets and corresponding nodes corresponding to data path devices of an SDN, and each node of these nodes may have multiple candidate immediate successor nodes, corresponding to multiple candidate execution paths and multiple candidate network routing paths. The priorities of the candidate execution paths may be dynamically adjusted based on current network metrics (e.g., metrics representing bandwidth and latency). In accordance with some implementations, executing tasks of the DAG’s tasksets may dynamically adjust the priorities based on current network metrics.

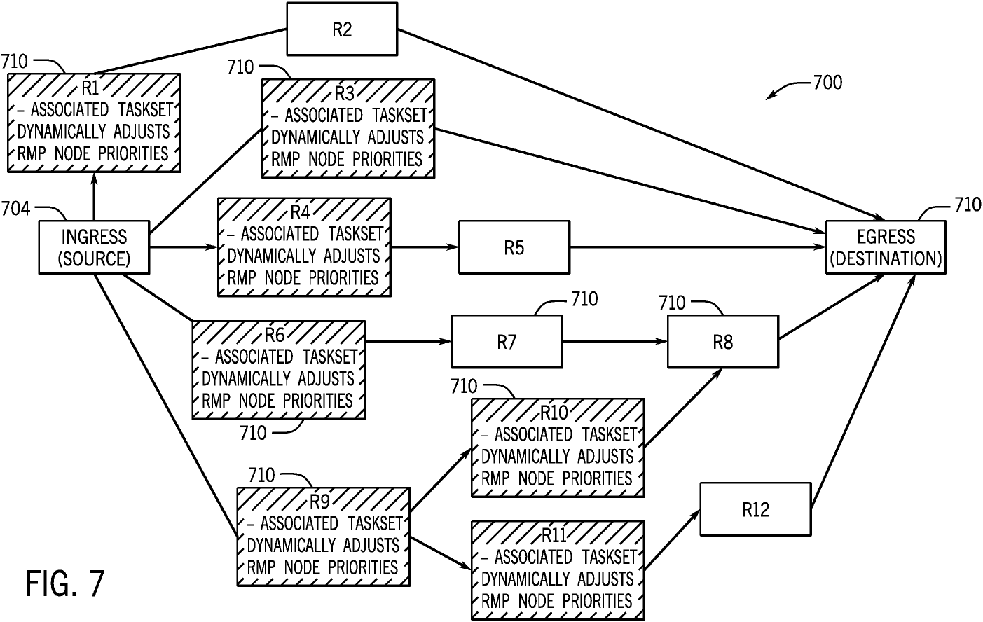

FIG. 7 depicts a data plane 700 of an SDN in accordance with an example implementation. In particular, the data plane 700 includes data path elements 710 of the data plane layer 700 between an ingress point 704, or source, and an egress point 710, or destination. The data path elements 710 may be selected in the routing of packets through the data plane 700 in one of multiple different paths. In FIG. 7, the cross-hatched data path elements 710 represent elements associated with different candidate data routing paths. In accordance with example implementations, each of the data path elements 710 may be associated with a particular taskset of a priority DAG. Correspondingly, the cross-hatched data path elements 710 of FIG. 7 may be associated with corresponding RMP node priorities. In accordance with example implementations, a given taskset may, depending on network metrics (e.g., bandwidth, latency, and so forth) adjust a priority of the associated node of the priority DAG based on network metrics associated with the data path element 710. In this manner, the executing tasks of a particular taskset, may dynamically adjust the RMP node priority of the corresponding node of the priority DAG to account for changing network conditions.

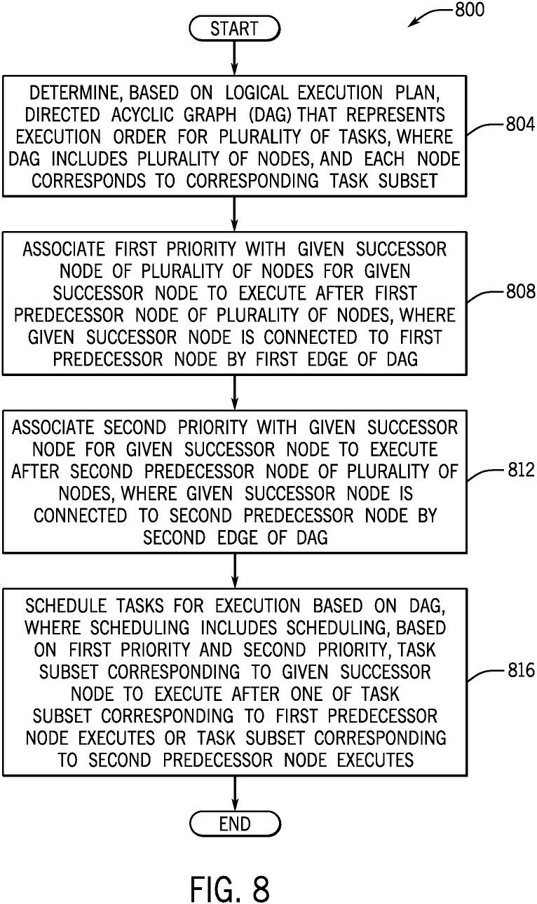

Referring to FIG. 8, in accordance with example implementations, a process 800 includes providing (block 804) a directed acyclic graph (DAG) that represents an execution order for a plurality of tasks. The DAG includes a plurality of nodes, and each node corresponds to a corresponding task subset of at least one task of the set of tasks. The process 800 includes associating (block 808) a first priority with a given successor node for the given successor node to execute after a first predecessor node. The given successor node is connected to the first predecessor node by a first edge of the DAG. The process 800 includes associating (block 812) a second priority with the given successor node for the given successor node to execute after a second predecessor node. The given successor node is connected to the second predecessor node by a second edge of the DAG. The process 800 includes scheduling (block 816) tasks for execution based on the DAG. The scheduling includes, based on the first and second priority, scheduling the task subset corresponding to the given successor node to execute after the task subset corresponding to the first predecessor node executes; or scheduling the task subset corresponding to the given successor node to execute after the task subset corresponding to the second predecessor node executes.

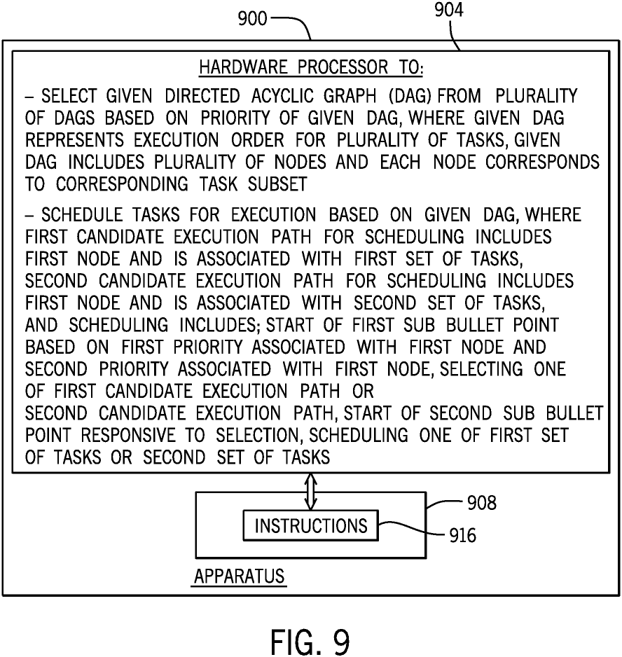

Referring to FIG. 9, in accordance with example implementations, an apparatus 900 includes a hardware processor 904 and a memory 908. The memory 908 stores instructions 916 that, when executed by the hardware processor 904, cause the hardware processor 904 to select a given directed acyclic graph (DAG) from a plurality of DAGs based on a priority of the given DAG. The given DAG represents an execution order for a plurality of tasks, the DAG includes a plurality of nodes, and each node corresponds to a corresponding task subset of at least one task of the set of tasks. The instructions 916, when executed by the hardware processor 904, cause the hardware processor 904 to schedule tasks of the plurality of tasks for execution based on the given DAG. A first candidate execution path for the scheduling includes a first node and is associated with a first set of tasks, a second candidate execution path for the scheduling includes the first node and is associated with a second set of tasks. The scheduling includes, based on a first priority associated with the first node and a second priority associated with the first node, selecting one of the first candidate execution path or the second candidate execution path; and responsive to the selection, scheduling one of the first set of tasks or the second set of tasks.

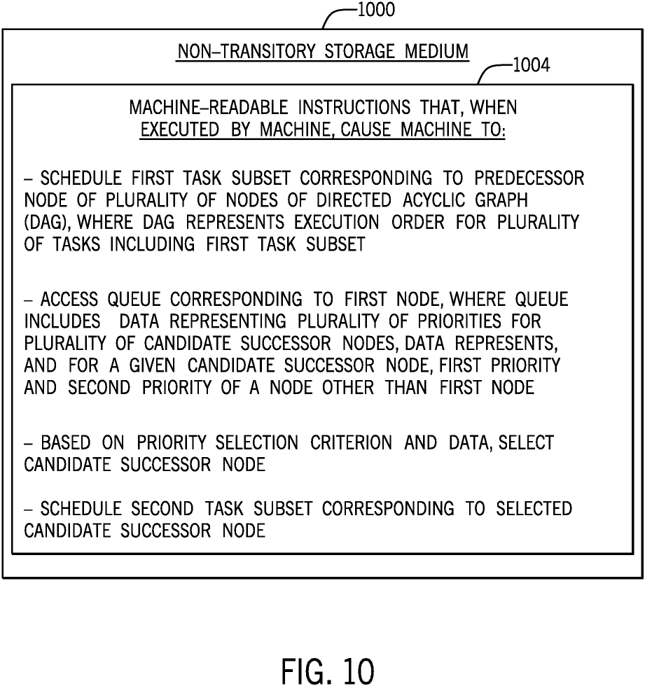

Referring to FIG. 10, in accordance with example implementations, a non-transitory machine-readable storage medium 1000 stores instructions 1004 that, when executed by a machine, cause the machine to schedule a first test subset corresponding to a predecessor node of a plurality of nodes of a directed acyclic graph (DAG). The DAG represents an execution order for a plurality of tasks that include the first task subset. The instructions 1004, when executed by the machine, further cause the machine to access a queue that corresponds to the first node. The queue includes data representing a plurality of priorities for a plurality of candidate successor nodes. The data represents, for a given candidate successor node, a first priority corresponding to the first node and a second priority of the plurality of priorities corresponds to a node other than the first node. The instructions 1004, when executed by the machine, further cause the machine to, based on a priority selection criterion and the data, select a candidate successor node to provide a selected candidate successor node. The instructions 1004, when executed by the machine, further cause the machine to schedule a second task subset of the plurality of tasks corresponding to the selected candidate successor node.

In accordance with example implementations, the DAG includes a given DAG of a plurality of DAGs, and the process further includes performing the scheduling responsive to the priority of the given DAG.

In accordance with example implementations, the schedule includes accessing a set of queues corresponding to the given DAG. Each queue corresponds to a node of the plurality of nodes and stores data representing available scheduling paths for the node and priorities associated with the available scheduling paths.

In accordance with example implementations, the task subset corresponding to the given successor node is associated with another DAG.

In accordance with example implementations, the process includes associating a third priority with a second successor node for the second successor node to execute after a third predecessor node; and associating a fourth priority with a third successor node for the third successor node to execute after the third predecessor node. The scheduling of the plurality of tasks further includes, based on the third priority and the fourth priority, scheduling the task subset corresponding to the second successor node to execute after the task subset corresponding to the third predecessor node, or scheduling the task subset corresponding to the third successor node to execute after the task subset corresponding to the third predecessor node.

In accordance with example implementations, the scheduling includes scheduling tasks for execution by a plurality of compute nodes of a cluster.

In accordance with example implementations, the scheduling includes accessing a hash map corresponding to the given successor node. Based on the hash map, a queue corresponding to the given successor node is accessed. The queue includes data representing the first priority and the second priority.

In accordance with example implementations, the DAG is associated with multiple scheduling paths, and each scheduling path is associated with a result of the plurality of results.

In accordance with example implementations, the process includes associating a plurality of priorities with the plurality of nodes and during the scheduling, changing a given priority of the plurality of priorities.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A method comprising:
providing a directed acyclic graph (DAG) that represents an execution order for a plurality of tasks, wherein the DAG comprises a plurality of nodes, and each node corresponds to a corresponding task subset of at least one task of the set of tasks;
associating a first priority with a given successor node of the plurality of nodes for the given successor node to execute after a first predecessor node of the plurality of nodes, wherein the given successor node is connected to the first predecessor node by a first edge of the DAG;
associating a second priority with the given successor node for the given successor node to execute after a second predecessor node of the plurality of nodes other than the first predecessor node, wherein the given successor node is connected to the second predecessor node by a second edge of the DAG; and
scheduling tasks of the plurality of tasks for execution based on the DAG, wherein the scheduling comprises, based on the first priority and the second priority:
scheduling the task subset corresponding to the given successor node to execute after the task subset corresponding to the first predecessor node executes; or
scheduling the task subset corresponding to the given successor node to execute after the task subset corresponding to the second predecessor node executes.

2. The method of claim 1, wherein the DAG comprises a given DAG of a plurality of DAGs, the method further comprising performing the scheduling responsive to the priority of the given DAG.

3. The method of claim 2, wherein the scheduling comprises:
accessing a set of queues corresponding to the given DAG, wherein each queue of the set of queues corresponds to a node of the plurality of nodes and stores data representing available scheduling paths from the node and priorities associated with the available scheduling paths.

4. The method of claim 1, wherein the task subset corresponding to the given successor node is associated with another DAG.

5. The method of claim 1, further comprising:
associating a third priority with a second successor node of the plurality of nodes for the second successor node to execute after a third predecessor node; and
associating a fourth priority with a third successor node of the plurality of nodes for the third successor node to execute after the third predecessor node,
wherein the scheduling of the plurality of tasks further comprises, based on the third priority and the fourth priority:
scheduling the task subset corresponding to the second successor node to execute after the task subset corresponding to the third predecessor node; or
scheduling the task subset corresponding to the third successor node to execute after the task subset corresponding to the third predecessor node.

6. The method of claim 1, wherein the scheduling of the tasks comprises scheduling tasks for execution by a plurality of compute nodes of a cluster.

7. The method of claim 1, wherein the scheduling comprises:
accessing a hash map corresponding to the given successor node;
based on the hash map, accessing a queue corresponding to the given successor node, wherein the queue comprises data representing the first priority and the second priority.

8. The method of claim 1, wherein:
the DAG is associated with multiple scheduling paths; and
each scheduling path of the multiple scheduling paths is associated with a result of a plurality of results.

9. The method of claim 1, further comprising:
associating a plurality of priorities with the plurality of nodes; and
during the scheduling, changing a given priority of the plurality of priorities.

10. An apparatus comprising:
a hardware processor; and
a memory to store instructions that, when executed by the hardware processor, cause the hardware processor to:
select a given directed acyclic graph (DAG) from a plurality of DAGs based on a priority of the given DAG, wherein the given DAG represents an execution order for a plurality of tasks, the DAG comprises a plurality of nodes, each node corresponds to a corresponding task subset of at least one task of the set of tasks; and
schedule tasks of the plurality of tasks for execution based on the given DAG, wherein a first candidate execution path for the scheduling comprises a first node of the plurality of nodes and is associated with a first set of tasks of the plurality of tasks, a second candidate execution path for the scheduling other than the first candidate execution path comprises the first node and is associated with a second set of tasks of the plurality of tasks, and the scheduling comprises:
based on a first priority associated with the first node and a second priority associated with the first node, selecting one of the first candidate execution path or the second candidate execution path; and
responsive to the selection, scheduling one of the schedule the first set of tasks or the second set of tasks.

11. The apparatus of claim 10, wherein the instructions, when executed by the hardware processor, further cause the hardware processor to:
access a hash map associated with a second node of the plurality of nodes, wherein the second node is a predecessor to the first node;
responsive to the hash map, access a priority queue associated with the second node; and
access the priority queue to determine the first priority.

12. The apparatus of claim 10, wherein the instructions, when executed by the hardware processor, further cause the hardware processor to, during the scheduling of the tasks, change a priority associated with a given node of the plurality of nodes.

13. The apparatus of claim 10, wherein the instructions, when executed by the hardware processor, further cause the hardware processor to:
based on a third priority associated with a second node of the plurality of nodes and a fourth priority associated with a third node of the plurality of nodes, select a third candidate execution path that includes the second node or fourth candidate execution path that includes the third node, wherein the third candidate execution path is associated with a third set of tasks of the plurality of tasks, the fourth candidate execution path is associated with a fourth set of tasks of the plurality of tasks; and
responsive to the selection of the third candidate execution path or the fourth candidate execution path, schedule one of the third set of tasks or the fourth set of tasks.

14. A non-transitory machine-readable storage medium to store instructions that, when executed by a machine, cause the machine to:
schedule a first task subset corresponding to a predecessor node of a plurality of nodes of a directed acyclic graph (DAG), wherein the DAG represents an execution order for a plurality of tasks comprising the first task subset;
access a queue corresponding to the first node, wherein the queue comprises data representing a plurality of priorities for a plurality of candidate successor nodes, wherein the data represents, for a given candidate successor node of the plurality candidate successor nodes, a first priority of the plurality of priorities corresponding to the first node and a second priority of the plurality of priorities corresponding to a node of the plurality of nodes other than the first node;
based on a priority selection criterion and the data, select a candidate successor node of the plurality of candidate successor nodes to provide a selected candidate successor node; and
schedule a second task subset of the plurality of tasks corresponding to the selected candidate successor node.

15. The storage medium of claim 14, wherein the instructions, when executed by the machine, further cause the machine to:
select the DAG from a plurality of DAGS based on priorities associated with the plurality of DAGs.

16. The storage medium of claim 15, wherein the instructions, when executed by the machine, further cause the machine to select a queue set corresponding to the selected DAG and select the queue from the selected queue set.

17. The storage medium of claim 14, wherein at least one of the first task subset or the second task subset comprises a DAG.

18. The storage medium of claim 14, wherein the instructions, when executed by the machine, further cause the machine to access the queue based on a hash map associated with the first node.

19. The storage medium of claim 14, wherein the instructions, when executed by the machine, further cause the machine to access a linked list associated with the first node to identify the plurality of candidate successor nodes.

20. The storage medium of claim 14, wherein the instructions, when executed by the machine, further cause the machine to schedule the first task subset for execution by at least one compute node of a cluster of compute nodes.
